(19) United States
(12) Patent Application Publication
(10) Pub. No.: US 2026/0341959 A1
(43) Pub. Date: Oct. 29, 2026

(54) HOLOGRAPHIC ANTENNA WITH DUAL POLARIZATION AND BIAS CONTROL USING HYBRID BEAMFORMING

(71) Applicant: Samsung Electronics Co., Ltd., Suwon-si (KR)

(72) Inventors: Aditya Dave, Plano, TX (US); Navneet Sharma, Plano, TX (US); Won Suk Choi, McKinney, TX (US); Gang Xu, Allen, TX (US)

(21) Appl. No.: 19/654,171

(22) Filed: Apr. 21, 2026

Related U.S. Application Data
(60) Provisional application No. 63/795,176, filed on Apr. 25, 2025.

(51) Int. Cl. H01Q 3/26; H01Q 21/06

(52) U.S. Cl. CPC H01Q 3/2676; H01Q 21/061

(57) ABSTRACT

Apparatuses and methods for holographic beam forming (HBF) are provided. A BS includes at least one HBF antenna array which includes a first layer including at least one first HBF antenna line formed thereon that is orientated at a first angle and includes at least one first gap, at least one second HBF antenna line formed thereon that is orientated at a second angle and includes at least one second gap. The second angle is opposite the first angle. At least one first and second varactor is formed in the at least one first and second air gaps. A second layer is attached to the first layer. A third layer is attached to the second layer and includes a direct current (DC) bias line connected to the first and second varactors, and a transceiver is coupled with the at least one HBF antenna array and to transmit or receive signals.

### CROSS-REFERENCE TO RELATED APPLICATION AND CLAIM OF PRIORITY

This application claims priority under 35 U.S.C. § 119(e) to U.S. Provisional Patent Application No. 63/795,176 filed on Apr. 25, 2025. The above-identified provisional patent application is hereby incorporated by reference in its entirety.

### TECHNICAL FIELD

This disclosure relates generally to Millimeter-Wave (mmWave) systems. More specifically, this disclosure relates to apparatuses and methods for a holographic antenna with dual polarization and bias control using hybrid beamforming.

### BACKGROUND

Millimeter-Wave (mmWave) 5G systems require use of large number of antenna elements to achieve sufficient gain to meet the radiated power threshold for large coverage areas. In frequency range 2 (FR2) systems, each antenna element is driven by a separate complimentary metal-oxide-semiconductor (CMOS) power amplifier or low-noise-amplifier, which leads to large panel costs and has low direct current (DC) to radio frequency (RF) power efficiency. Recently, a new type of holographic theory-based beamforming provides a reduced number of RF chains for lower cost, and ability to use high performance gallium arsenide (GaAs) power amplifiers. By leveraging guided wave excitation, the holographic antenna can create beam scanning by using active tuning elements like varactors or pin-diodes, to emulate performance of phased-arrays. The typical holographic antennas however, suffer from single polarization and complex bias control mechanism to control the tuning elements.

### SUMMARY

This disclosure provides apparatuses and methods for a holographic antenna with dual polarization and bias control using hybrid beamforming.

In one embodiment, a base station (BS) is provided. The BS includes at least one holographic beam forming (HBF) antenna array including a first layer including at least one first HBF antenna line formed thereon, the at least one first HBF antenna line orientated at a first angle and including at least one first gap, at least one second HBF antenna line formed thereon, the at least one second HBF antenna line orientated at a second angle and including at least one second gap, wherein the second angle is orientated opposite the first angle, and at least one first varactor formed in the at least one first gap and at least one second varactor formed in the at least one second gap, a second layer attached to the first layer and including an isolating ground plate, and a third layer attached to the second layer and including a direct current (DC) bias line connected to both the at least one first varactor and the at least one second varactor, and a transceiver operably coupled with the at least one HBF antenna array, the transceiver configured to transmit or receive signals using the at least one HBF antenna array.

In another embodiment, An HBF antenna array is provided. The HBF antenna array includes a first layer including at least one first HBF antenna line formed thereon, the at least one first HBF antenna line orientated at a first angle and including at least one first gap, at least one second HBF antenna line formed thereon, the at least one second HBF antenna line orientated at a second angle and including at least one second gap, wherein the second angle is orientated opposite the first angle, and at least one first varactor formed in the at least one first gap and at least one second varactor formed in the at least one second gap, a second layer attached to the first layer and including an isolating ground plate, and a third layer attached to the second layer and including a DC bias line connected to both the at least one first varactor and the at least one second varactor, and a transceiver operably coupled with the at least one HBF antenna array, the transceiver configured to transmit or receive signals using the at least one HBF antenna array.

In another embodiment a method for operating a BS is provided. The method includes forming at least one HBF antenna array including a first layer including at least one first HBF antenna line formed thereon, the at least one first HBF antenna line orientated at a first angle and including at least one first gap, at least one second HBF antenna line formed thereon, the at least one second HBF antenna line orientated at a second angle and including at least one second gap, wherein the second angle is orientated opposite the first angle, and at least one first varactor formed in the at least one first gap and at least one second varactor formed in the at least one second gap, a second layer attached to the first layer and including an isolating ground plate, and a third layer attached to the second layer and including a DC bias line connected to both the at least one first varactor and the at least one second varactor, and operably coupling a transceiver with the at least one HBF antenna array, the transceiver configured to transmit or receive signals using the at least one HBF antenna array.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIG. 2 illustrates an example base station (BS) according to embodiments of the present disclosure;

FIG. 3 illustrates an example of a user equipment (UE) according to embodiments of the present disclosure;

FIG. 4 illustrates two antenna arrays according to embodiments of the present disclosure;

FIG. 5 illustrates an example holographic beam forming (HBF) antenna panel according to embodiments of the present disclosure;

FIG. 6 illustrates graph illustrating an example steer angle according to embodiments of the present disclosure;

FIG. 7. illustrates a flow chart of a method for HBF antenna array design according to embodiments of the present disclosure;

FIG. 8 illustrates a HBF antenna array according to one or more embodiments of the present disclosure;

FIG. 9 illustrates an example antenna stack-up according to one or more embodiments of the present disclosure;

FIG. 10 illustrates a 3D view of the example antenna stack-up of FIG. 9 according to embodiments of the present disclosure;

FIG. 11 illustrates a top-view of the metal spacer according to embodiments of the present disclosure;

FIG. 12 illustrates a top-view of the superstrate according to one or more embodiments of the present disclosure;

FIG. 13 illustrates a graph showing an example scanning range of a polarized array with co-polarized and cross-polarized gains for different beam scanning angles;

FIG. 14 illustrates a graph showing an example radiation and total efficiency of the HBF antenna array;

FIG. 15 illustrates a scaled HBF antenna array according to embodiments of the present disclosure;

FIG. 16 illustrates a metal spacer according to one or more embodiments of the present disclosure;

FIG. 17 illustrates an example antenna stack-up according to embodiments of the present disclosure; and

FIG. 18 illustrates a flow diagram of a method for operation a BS for communication using a HBF antenna array.

### DETAILED DESCRIPTION

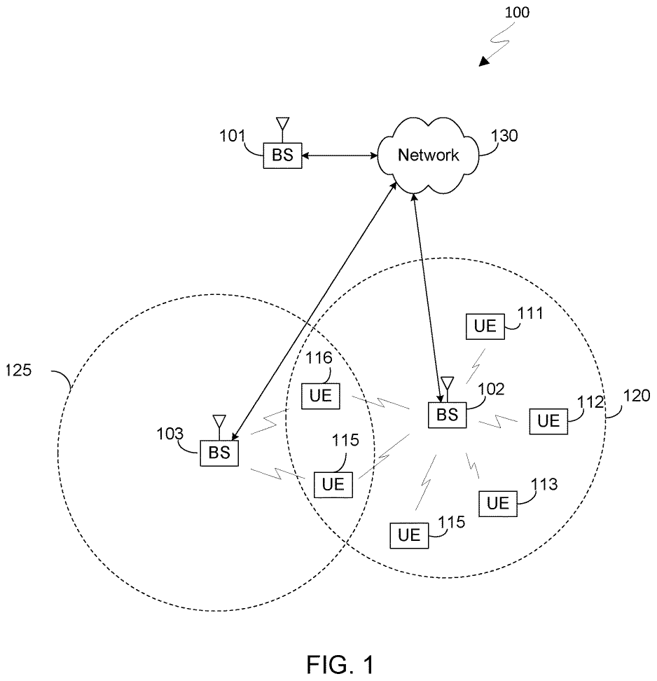

FIGS. 1-18, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

For millimeter wave (mmWave) systems, it may be useful to increase the effective isotropic radiated power (EIRP) to increase the coverage range of base-stations and make frequency level (FR2) products more viable. The EIRP on the transmit side is proportional to Pt*Gt, where Pt is output power of the power amplifiers (PAS) and Gt is the gain of the antenna array. Hence EIRP can be increased in two ways—by increasing the PA power, or by increasing the gain of the antenna array. The latter is achieved by using a larger antenna panel with more elements. The base-stations solutions are typically limited by panel area and cannot be increased above a certain limit. Hence, one possible way is to increase Pt is by using high power PAs. There are two main implementation challenges for this. High power PAs are costlier. If high-power PAs are used, the overall system cost becomes unviable to implement. High power PAs also occupy a larger size. It is may not be possible to replace a complimentary metal-oxide-semiconductor (CMOS) PA with a high power gallium nitride/gallium arsenide (GaN/GaAs) PA since the footprint for the latter is much larger.

This disclosure relates to architectures that can use fewer number of PAs without sacrificing beam steering performance of the system. A practical way to reduce the number of PAs is the use of subarray. One PA's output is divided to multiple antennas by use of a power divider. However, for really large antenna array lengths, may be needed to have complex power divider implementations that incur large transmission losses. Furthermore, a power divider antenna array typically supplies all antenna elements with the same magnitude and phase of a radio frequency (RF) signal. For maintaining beam steerability as one PA per element system, it may be useful for each antenna element to have independent phase control.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a base station (BS) 101 a BS 102, and a BS 103. The BS 101 communicates with the BS 102 and the BS 103. The BS 101 also communicates with at least one network 130, such as the Internet, a proprietary Internet Protocol (IP) network, or another data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB) a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the BSs include a holographic antenna with dual polarization and bias control using hybrid beamforming.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

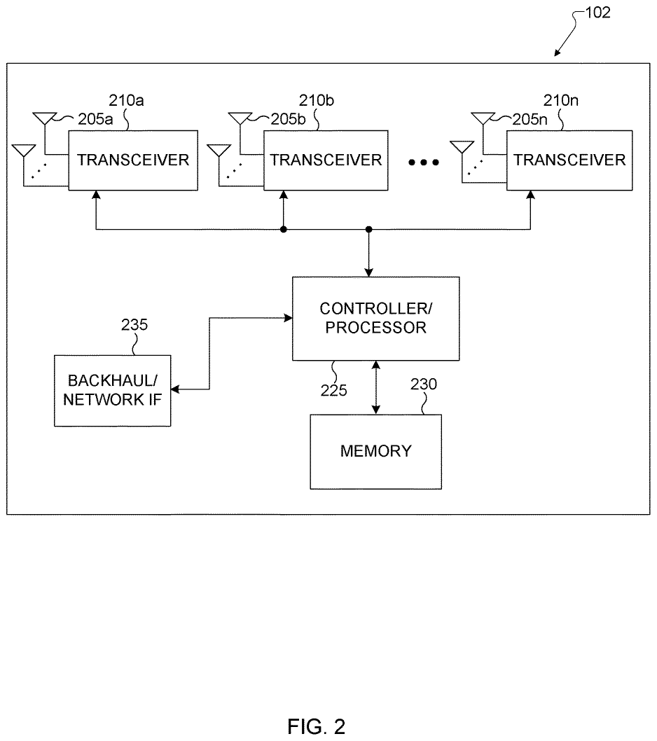

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as processes for a transmitting using a holographic antenna with dual polarization and bias control using hybrid beamforming. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

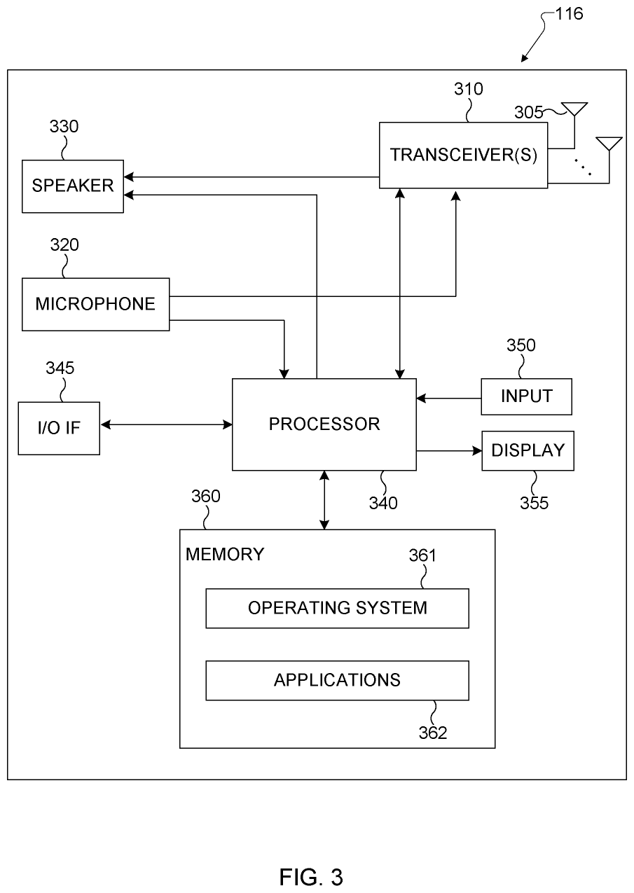

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. For example, in various embodiments, the UE 116 uses dual polarization and bias control using hybrid beamforming.

In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

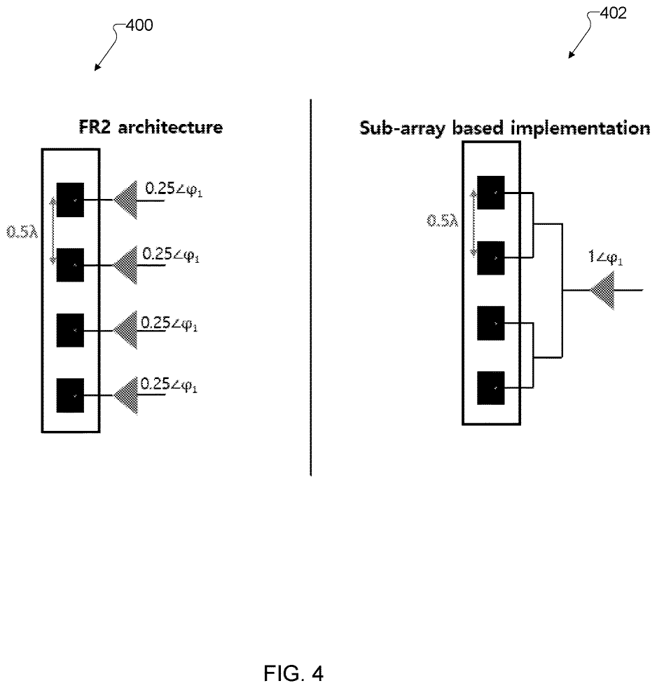

FIG. 4 illustrates an antenna array 400 and an antenna array 402 according to embodiments of the present disclosure. The antenna array 400 is a FR2 architecture that includes one PA per element versus an antenna array 402 that includes subarray-based implementation that restricts magnitude and phase control for each element. To avoid complex power dividers and associated losses for long antenna sub-arrays, various embodiments of the present disclosure provide architectures where antenna length is larger and no subarray may be required.

As noted above, mmWave 5G systems suffer from low coverage and large panel costs. As a result, there may be need to increase the EIRP of the panel, in order to get higher coverage with greater throughput and make the mmWave panels worth the investment for network operators. EIRP improvement can be achieved using larger antenna panel gain or increasing the PA power, or a combination of both. The current FR2 architecture supports full analog beam steering in both azimuth and elevation directions with one PA per antenna element. As a result, if the antenna panel size is increased, a greater number of PAs may be required. Low cost CMOS process can be used to minimize PA cost, but CMOS process doesn't have ability to support high powers to increase EIRP. If a larger power supporting process like InP, or GaN is used, it makes the cost of the panel too high. Solutions are thus provided herein to scale the size of the mmWave antenna panel without using a very large number of PAs, giving the ability to operate each PA at a much higher power and efficiency, and still maintain overall cost.

Holographic beamforming (HBF) is seen as a good alternative to scale the antenna panel size. The holographic approach is based on using periodic unit cells with finite leakage based on Floquet theory. In the past, holographic structures were developed to show azimuth and elevation beam steering using only varactor tuning elements on each unit cell. However, such an approach uses waveguide-based splitting from 1 PA and can hence support only single polarization. Also, each tuning element needs to be separately biased for independently generating different capacitance values, which increases the bias complexity for large designs. Other approaches have shown reduction in bias complexity by using a leaky wave approach to tune the impedance of the holographic surface using only one varactor bias for each HBF row. However, these structures operate with only single polarization, and only support a subset of steering ranges between ±45° at low total efficiencies of below 50%. Certain dual-pol designs that can support left-hand circular (LHCP) and left-hand circular (RHCP) polarizations using 2 varactors for full azimuth beam steering. However, current FR2 infrastructure only support ±45° polarizations. Using LHCP/RHCP for commercial base-stations will incur additional 3 dB polarization loss due to misalignment.

This disclosure is related to a dual-polarized holographic antenna architecture with ±45° polarization and simplified full ±45° azimuth beam steering using 1 varactor per polarization. To steer in azimuth direction, the architecture uses digital phase shifters with 1 high power GaAs PA to feed each row of HBF antenna. The resultant design can be scaled to support a high EIRP BS antenna panel or a low-cost consumer premise equipment (CPE). The high EIRP panel uses less DC power than the scaled typical FR2 design. Alternatively, a smaller formfactor version can be used in mmWave CPEs providing additional cost savings.

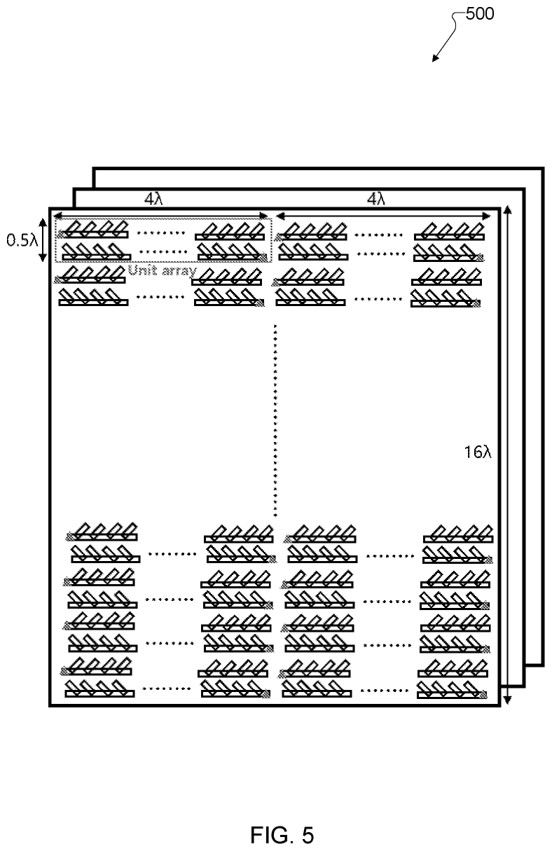

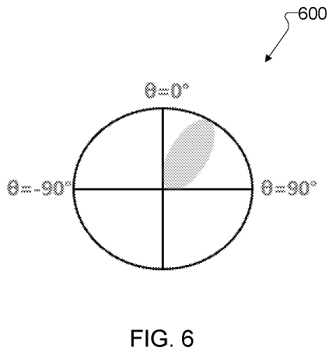

FIG. 5 illustrates an example HBF antenna panel 500 according to embodiments of the present disclosure. FIG. 6 illustrates graph 600 illustrating an example steer angle according to embodiments of the present disclosure.

In one or more embodiments, an HBF antenna array can include one or more antenna panels such as the HBF antenna panel 500. In one or more embodiments, the HBF antenna panel 500 allows an HBF antenna array to support 81 dBm EIRP target. As noted above, the 81 dBm EIRP target is for example purposes only. As illustrated in FIG. 5, the HBF antenna panel 500 includes a plurality of unit arrays. Each unit antenna array includes sub-wavelength spaced small resonators fed in series using a travelling wave on a microstrip line. In one or more embodiments there is a spacing between the unit cells within each unit array of about 0.13λ and the length of the antenna row (also referred to herein as “rows”) is about 4λ at about 28 GHz, where λ is the free space wavelength at the operating frequency. Hence in one example, each unit array includes 30 unit cells with 3 varactors on each unit cell (described in more detail below). This is for example purposes only, and each unit array can include any suitable quantity of unit cells and varactors. Also as noted above, the spacings, lengths, and any other distances described herein are for example purposes only, and any suitable lengths, spacings, or other described distances can be used.

In one or more embodiments, the unit cells are oriented such that each alternate row supports the same +45° or −45° polarization, or any other opposite polarization. The spacing between the alternate rows is maintained at about 0.5λ to ensure that there is no beam steering penalty through increased side lobe magnitude in elevation direction. Each row is fed using a PA from the bottom on one side. The other side is terminated in an about 50Ω matched load. Although an about 50Ω matched load is described, this is for example purposes only and any suitable matched load can be used. In one or more embodiments, the HBF antenna panel 500 can include 32 rows and 2 columns of the unit arrays. Hence each antenna panel includes 64 PAs per polarization. This is for example purposes only and the antenna panels can include any suitable quantity of rows and columns of the unit array. One such antenna panel can provide 71.4 dBm of EIRP as indicated in Table 1 (shown below). Thus, by using the antenna panels side-by-side, 81 dBm of EIRP can be obtained. It is understood that the EIRP described is for example purposes only and any suitable quantity of antenna panels can be used to obtain any desired EIRP.

The HBF antenna panel 500 can be based on travelling wave antennas that are excited by using a guided wave propagating along a microstrip transmission line. The transmission line includes periodic resonators that present a complex surface impedance Zs to the travelling wave. By carefully controlling the surface impedance, radiating modes can be generated using leaky wave approach.

The HBF antenna panel 500 can be termed as a periodic leaky wave antenna (LWA) when the guiding structure supports a slow wave such that β<k₀. The fundamental non-radiating guided wave mode, which is quasi-traverse electromagnetic (quasi-TEM) in case of a microstrip line, is made to radiate by introducing periodicity along the length of the structure as shown by the white rectangles that represents slots in FIG. 5. The field on this transmission line is then characterized by infinite number of space harmonics with wave number on the nth slot on the x direction given by

$${k}_{x , n} = {k}_{x , 0} + \frac{2 π n}{p}$$

where p is the periodicity of the unit cell. In FIG. 2, p=a. The main advantages of the periodic LWA is that it can create both a forward and backward wave since β₋₁=Re(k_{x,-1}) can be either positive or negative.

Whenever the LWA is fed at the center, it creates bidirectional dual-beam radiation. When the LWA is fed at the edge, the radiating field or current ψ(x) has the form given by

ω(x)=Ae^{-k}^{ₓ}^{x}
where kₓ=β−jα which is the complex wave number. Here β>0 represents a fast wave indicated by a positive propagation constant and β<0 represents a slow wave. A determines the loss of the structure due to periodic unit cells. Most of the energy loss in the unit cells is because of radiation, hence eᵣ=1−e^{-2αL} represents overall efficiency. Using close to 90% eᵣ gives loss due to each unit cell which can be used to determine the unit cell leakage and resonance. Depending on the value of β, the structure can support a steer angle to the left or right of boresight direction as shown in FIG. 6 below.

Furthermore, β=k₀ sin(θ) where θ∈[−90°,90°]. Hence when a beam is steered to the right side of boresight, β is positive and structure produces a forward or fast wave. When a beam is steered to the left side, β is negative and the structure produces a backward or slow wave. For steering at boresight, β is equal to zero and the structure should produce a standing wave.

For having the full steer range of −90 to +90, may be useful to have effective permittivity (ε_{eff}) of the quasi-TEM microstrip line to suffice Σ_{eff}>9 to avoid dual beams. In one or more embodiments, this can place the condition for design as

$$\frac{{β}_{0}}{{k}_{0}} > 3 .$$

As noted above, Table 1 shows the comparison of the phased array approach with the HBF antenna panel 500 based on GaAs PA efficiency and phased array link budget numbers. It can be seen that the HBF antenna panel 500, having nearly similar area with dual polarization capability, less PAs by a factor of 6 and consumes about 46% less power than other designs configured to support 82 dBm EIRP.

TABLE 1

| Parameter | Unit | Phased Array | HBF |
|---|---|---|---|
| Panel Size | λ² | 15λ(V) × 8λ(H) | 16λ(V) × 8λ(H) |
| Number of panels | # | 4 | 4 |
| Total area | λ² | 30λ(V) × 16λ(H) | 32λ(V) × 16λ(H) |
| Total area @ 28 GHz | cm² | 32 × 17.1 | 34.2 × 17.1 |
| Antenna gain per panel | dBi | 30.4 | 28.1 |
| Total antenna gain | dB | 36.4 | 34.1 |
| Total PAs per pol | # | 1536 | 256 |
| Per PA power | dBm | 11^{#} | 21.1* |
| Total PA power | dBm | 42.9 | 45.2 |
| Polarization multiplier | dB | 3 | 3 |
| TX EIRP Total | dBm | 82.3 | 82.3 |
| Power added eff | % | 9^{#} | 30* |
| Total DC draw for RF | W | 429.7 | 231.5 |
| Number of DACs | # | — | 2 |
| DC controller power | W | — | 1 |
| Total DC Power | W | 429.7 | 232.5 |

Therefore, the unit cell of the HBF antenna panel 500 can be based. The leaky-wave approach can be used to design a one-dimensional (1D) finite antenna element including multiple unit cells arranged periodically. Tuning elements like pin diodes or varactor diodes can be integrated on individual unit cells on change the Bn values in real time. This can create beam steering solutions via holographic antennas. Multiple 1D elements can be stacked vertically to create a two dimensional (2D) HBF array. Such an array can steer the beam in azimuth and elevation directions. In some embodiments, digital beamforming can be used to steer beam(s) in azimuth or elevation directions. In certain other embodiments, the beamforming in both azimuth and elevation directions can be fully accomplished analog using tuning elements like varactors or pin-diodes.

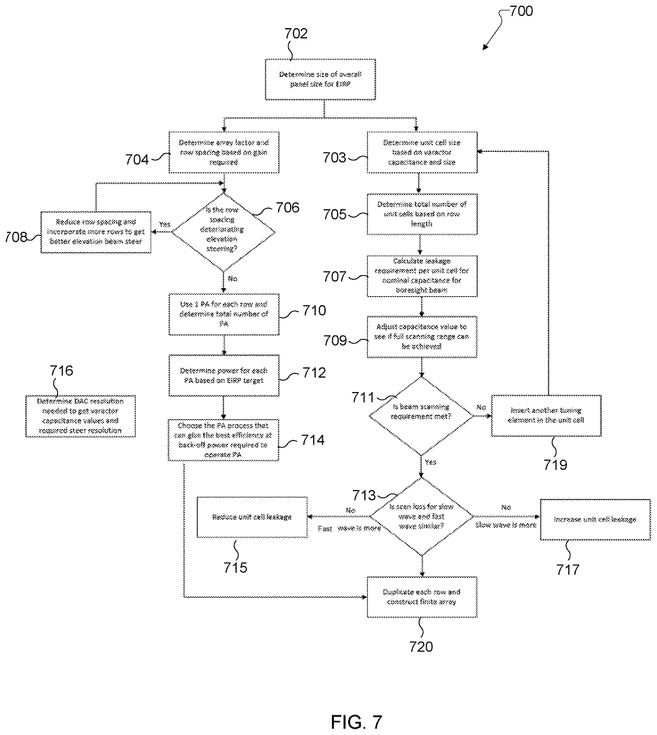

FIG. 7. Illustrates a flow chart of a method 700 for HBF antenna array design according to embodiments of the present disclosure. The embodiment of the method 700 shown in FIG. 7 is for illustration only. Other embodiments of the method 700 for HBF antenna array design could be used without departing from the scope of this disclosure.

As illustrated in FIG. 7, the method 700 begins with determining the overall antenna panel size for the antenna array (702). Depending on the vertical size of the antenna panel, the number of antenna rows (also referred to herein as “rows”) and spacing between the rows is determined and depending on the horizontal dimension of the antenna panel, the length of one row is determined. After determining the overall size of the antenna panel, the array factor and row spacing based on the gain required can be determined (704). Whether the row spacing is deteriorating elevation steering can be determined next (706). If the spacing between the rows is too large such that elevation steering range is reduced because of increased grating lobes, the row spacing must be reduced to meet the evaluation steering requirements (708). Once it is determined that the row spacing is not deteriorating elevation steering, the number of PAs are determined based on the quantity of rows (710). The gain of each row depends on the row length and the leakage of unit cells. By adding the array factor to the single row gain, depending on the number of rows, the total antenna gain can be determined. The power for each PA is then calculated by knowing the antenna gain and based on the EIRP requirement (712). Since the number of PAs are known, the per PA power can be obtained from total PA power and number of PAs. Depending on the average power per PA thus calculated, appropriate PA process(es) such as GaN, GaAs, CMOS, or the like, can be selected based on maximum efficiency of the corresponding process for the power required (714). For example, in certain embodiments where very high PA power may be required, a GaN PA process is chosen for maximum efficiency. Additionally, the digital-to-analog converter (DAC) to get varactor capacitance values (also referred to as “capacitance values”) and the required steer resolution are determined (716).

Concurrently, after determining the overall size of the antenna array, the unit cell size based on the varactor capacitance values and size can be determined (703) and the total number of unit cells based on row length can be determined (705). As noted above, the row length can be determined based on the horizontal dimension of the overall panel size. In one or more embodiments, based on number of tuning elements for getting the full steering range, the size of the unit cell can be determined. From there, the leakage requirement per unit cell for nominal capacitance for boresight beam can be determined (707). The leakage requirement can be determined (and further optimized) based on the row length and unit cell simulation can be verified using eigenmode and Floquet analysis. The eigenmode analysis provides whether appropriate normalized propagation constant for producing slow-wave and fast-wave behavior using the holographic antenna is possible. For example, if the normalized propagation constant is between −0.5 and +0.5, theoretically a steering range of −50° to +50° can be obtained. The normalized propagation constant (β) range can be maximized by introducing additional tuning elements in the unit cell at the cost of increasing the loss (α) and reducing radiation efficiency of the antenna. Based on the leakage requirement the capacitance value can be adjusted to see if a full scanning range can be achieved (709). After adjusting the capacitance valve, whether a beam scanning requirement is met can be determined (711). If the beam scanning requirement is not met, another tuning element is added in the unit cell (719) and the method 700 returns to operation 703.

On the other hand, once the scanning requirement is achieved, a finite one row of HBF antenna array is simulated (713). Ideally, the gain in the boresight direction would be maximum and scan loss to the left of boresight and right of boresight would be similar. The scanning to the left of boresight is achieved using slow-wave behavior of HBF characterized by a negative value of normalized β, and scanning to the right of boresight is achieved using fast-wave behavior of HBF characterized by a positive value of normalized β. If the scan loss for slow-wave is smaller than fast-wave, the unit cell leakage should be reduced and vice-versa (715-717), until optimal performance is obtained. If the slow-wave and the fast wave are similar and after the PA process(es) are selected (714) each row can be duplicated (720).

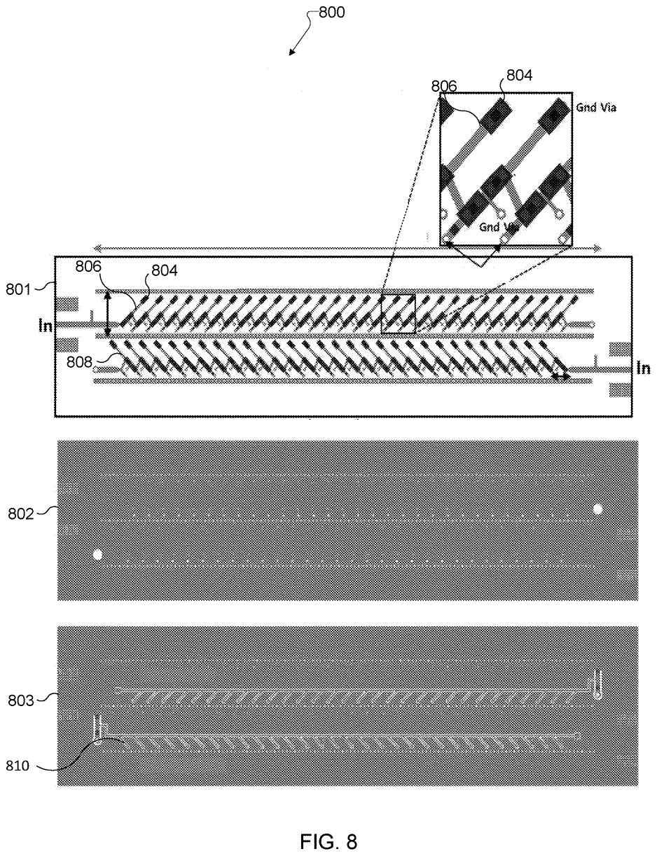

Using the method 700, an HBF antenna array can obtained as illustrated in FIG. 8. FIG. 8 illustrates a HBF antenna array 800 according to one or more embodiments of the present disclosure. Although the HBF antenna array 800 includes a single row, this is for example purposes only, and the HBF antenna array 800 can include any suitable quantity of rows. As noted above, the HBF antenna array 800 can be included in a BS, such as BS 102. In one or more embodiments, the HBF antenna array 800 is a printed circuit board (PCB).

As illustrated in FIG. 8, the HBF antenna array 800 includes a first layer 801, a second layer 802, and a third layer 803. The first layer 801 includes dual-pol HBF antenna. The first layer 801 includes at least one first HBF antenna line 806 orientated at a first angle and at least one second HBF antenna line 808 oriented at a second angle. The first angle and the second angle are oriented opposite of each other as indicated by two polarizations of lines oriented in +45° and −45° (or any other suitable opposite angles or polarizations). A spacing present between unit cells can be 0.08λ to 0.2λ, or any other suitable spacing depending on the unit cell leakage and normalized propagation constant range, where λ is the free space wavelength at the operating frequency. The spacing between the unit cells can also be related to the size of the unit cells which in turn depends on the number of tuning elements. In one or more embodiments, the at least one first HBF antenna line 806 and the at least one second HBF antenna line include at least one gap that includes a varactor diode 804 (also referred to as a “varactor”) positioned therein. In one or more embodiments, three varactor diodes 804 are positioned within three gaps on each of the at least one first HBF antenna line 806 and the at least one second HBF antenna line 808. The varactor diodes 804 offer a high quality-factor (Q) so that the overall loss can be minimized. Any suitable size of the varactor diodes 804 can be used based on the desired foot print of the HBF antenna array 800. Different varactors diodes 804 can be chosen based on their capacitance range, quality factor and cost trade-off, as suitable for the application. In one or more embodiments a chose resistor is also positioned on each of the at least one first HBF antenna line 806 and the at least one second HBF antenna line 808.

In one or more embodiments, the length of each unit cell is determined according to the row spacing. For example, it can be between about 0.2λ and about 0.4λ based on the unit cell inclination which in turn depends on the polarization. The second layer 802 includes RF and DC ground (an isolating ground plate) and has holes to carry through vias from the first layer 801 to the third layer 803. The third layer 803 includes a DC bias line design for feeding the varactor diodes 804. Advantageously the HBF antenna array 800 is able to use just one DC voltage to control each polarization and steer to within at least a dual polarization range. This is possible since each varactor diode 804 is tuned to the same capacitance value for one particular steer angle, which means all the varactor diodes 804 are biased to a same voltage level. DC bias lines 810 are shown on the third layer 803. The width of the DC bias lines 810 can be as small as permissible by PCB manufacturing limits. In one or more embodiments, the DC bias lines 810 are 4 mils wide or any other suitable width. As seen in the third layer 803, only one DC bias line 810 per polarization is needed, which reduces the bias complexity substantially.

In one or more embodiments, the standalone three layer HBF antenna array 800 can be capable of generating dual pol scanning. However, one important antenna metric is cross-polarization isolation that should be at least 15 dB as per the current BS antenna standards. A three layer HBF antenna can make it very difficult to maintain cross-pol isolation over all scan angles. Hence use of a polarizer sheet (also referred to herein as a “superstrate”) may be required to maintain the cross-pol isolation. This can be achieved by using another layer for the superstrate. The superstrate can be separated from the HBF antenna array 800 by using a hollow metal structure as described in more detail below.

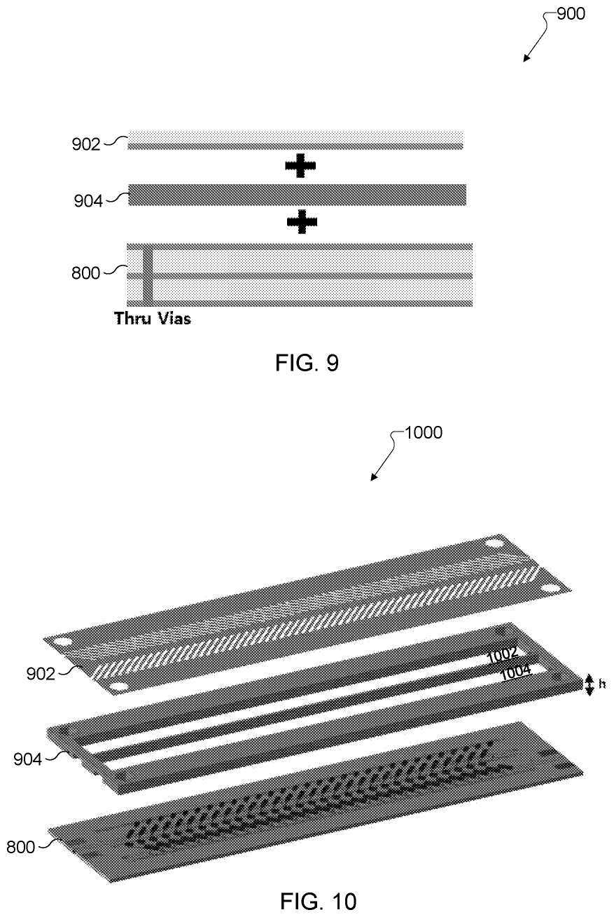

FIG. 9 illustrates an example antenna stack-up 900 according to one or more embodiments of the present disclosure. FIG. 10 illustrates a 3D view 1000 of the example antenna stack-up 900 of FIG. 9 according to embodiments of the present disclosure.

As illustrated in FIG. 9, the antenna stack-up 900 includes a metal spacer 904 positioned between a superstrate 902 and the HBF antenna array 800. In one or more embodiments, as noted above the HBF antenna array 800 can be a three-layer PCB with at least one thru via formed therein. In one or more embodiments, the layers of the HBF antenna array 800 can a tachyon PCB material separated by copper (Cu) layers. The material of the PCB is not limited by this disclosure.

As illustrated in FIG. 10, the metal spacer 904 includes a first air gap 1002 and a second air gap 1004. The first air gap 1002 corresponds to and is formed over the at least one first HBF antenna line 806. The second air gap 1004 corresponds to and is formed over the at least one second HBF antenna line 808. The metal spacer 904 also has a height h. In one or more embodiments, the height h can be at least larger than the height of the varactor diodes 804, such as about 0.5 mm. The height h and the air gap dimensions can be tuned to achieve optimal performance.

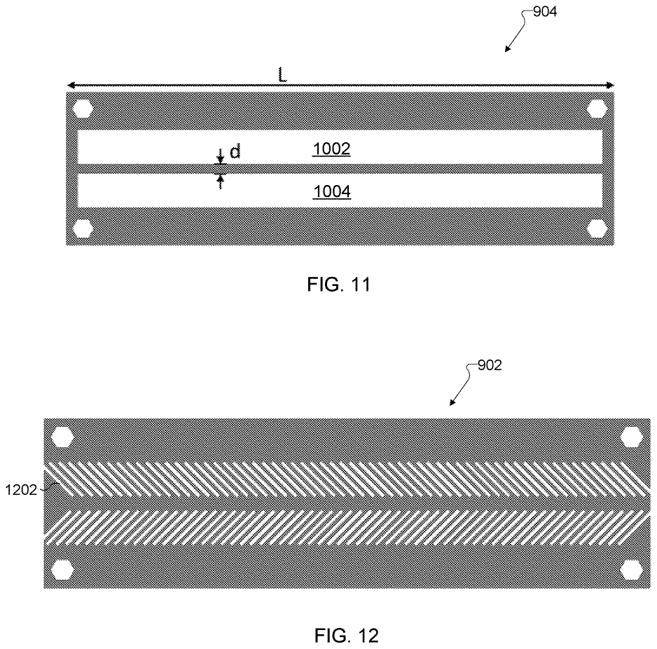

FIG. 11 illustrates a top-view of the metal spacer 904 according to embodiments of the present disclosure.

In one or more embodiments a thickness d of the portion of the metal spacer 904 between the airgaps is based on the HBF unit cell length and the spacing between the rows. In one or more embodiments the first air gap 1002 should be positioned above the at least one first HBF antenna line 806 and the second air gap 1004 should be positioned above the at least one second HBF antenna line 808 so that the HBF antenna array 800 can radiate and there is space to solder the tuning elements and passive components like a DC blocking resistor. A length L of the metal spacer 904 is dependent on the HBF antenna array 800 length and can be smaller than the overall board length to have enough space to solder the connectors. The portion of the metal spacer 904 between the airgaps width extends from the HBF antenna array 800 to the superstrate 902. This is to ensure that each polarization is isolated, so that the cross-pol isolation and mutual coupling requirements are met.

FIG. 12 illustrates a top-view of the superstrate 902 according to one or more embodiments of the present disclosure. As illustrated in FIG. 11 the superstrate 902 includes slots 1202 having a width of about 0.0λ to about 0.1λ. In one or more embodiments, spacing between the slots 1202 can be from about 0.03λ to about 0.25λ. These values are determined based on the superstrate leakage and the height h of the metal spacer 904.

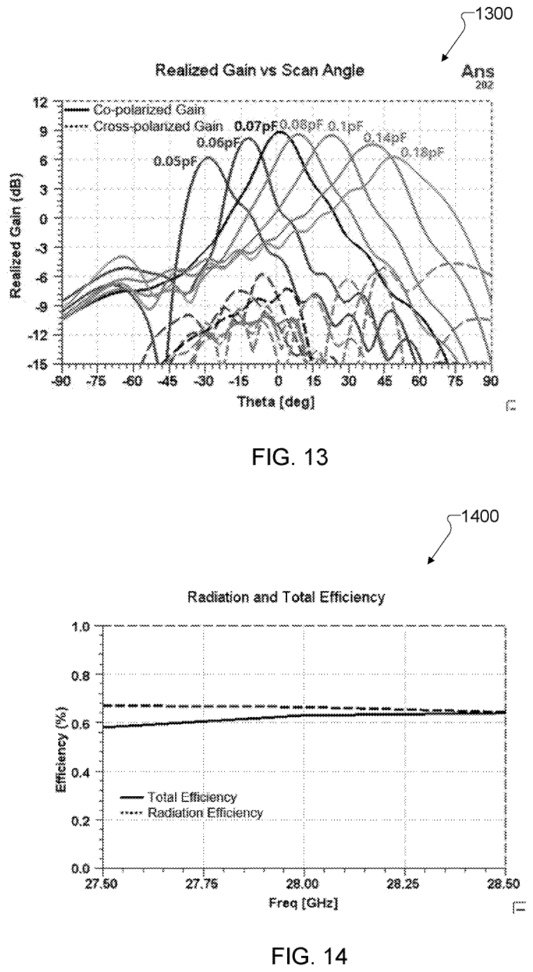

FIG. 13 illustrates a graph 1300 showing an example scanning range of a polarized array with co-polarized and cross-polarized gains for different beam scanning angles. FIG. 14 illustrates a graph 1400 showing an example radiation and total efficiency of the HBF antenna array 800.

The graph 1400 illustrates the radiation and total efficiency of the dual-polarization capable unit array. As shown in FIG. 14 a total efficiency of greater than 60% over 1 GHz centered around 28 GHz is achieved 20. The graph 1300 illustrates the beam scanning performance in azimuth direction with co-polarized and cross-polarized realized gain for 45° polarization with similar result for 135° polarization due to symmetric design. The result shows 3 dB beam scanning range from −30° to +50° and cross-pol isolation of >15 dB. It is important to note here that for each scan angle, all the high-Q varactors have the same capacitance. Hence only one DAC per polarization is needed to generate the required voltage value for the varactors as indicated in Table 1. This greatly simplifies the bias mechanism.

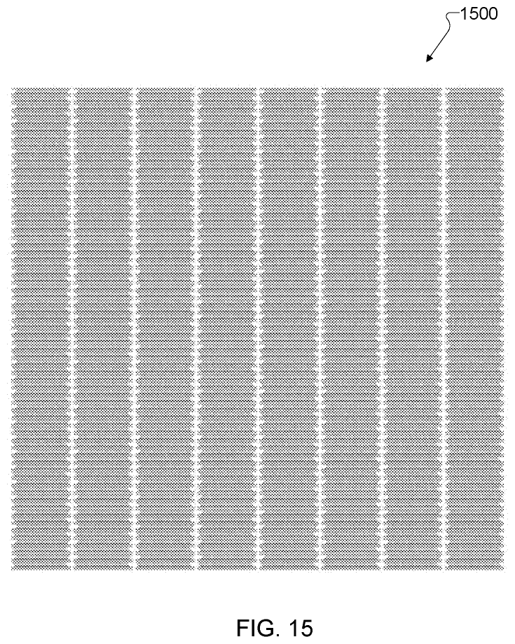

FIG. 15 illustrates a scaled HBF antenna array 1500 according to embodiments of the present disclosure. The HBF antenna array 1500 can be a one row HBF antenna for a 82 dBm EIRP antenna panel. In one or more embodiments, the HBF antenna array 1500 includes dimensions that are 34 cm by 17 cm, although any suitable dimensions can be used.

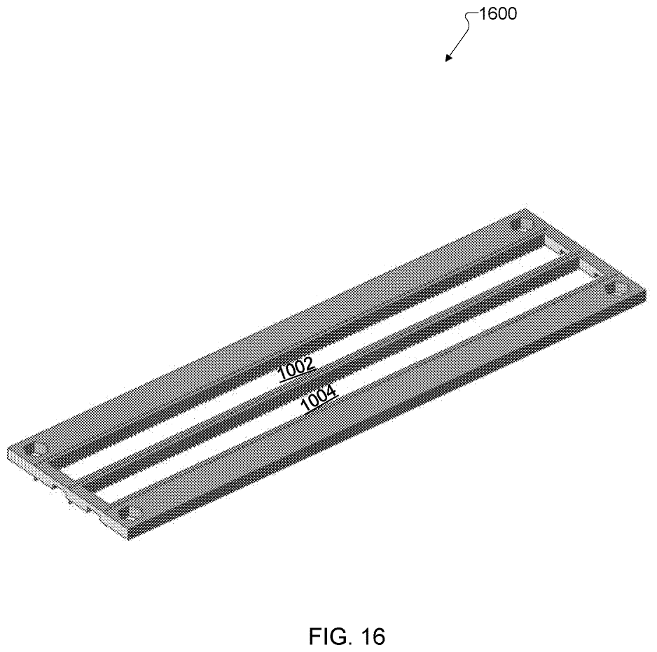

FIG. 16 illustrates a metal spacer 1600 according to one or more embodiments of the present disclosure. In one or more embodiments the metal spacer 1600 can be used in lieu of the metal spacer 904. The metal spacer 1600 can be a one-layer PCB structure with via walls as shown in FIG. 15.

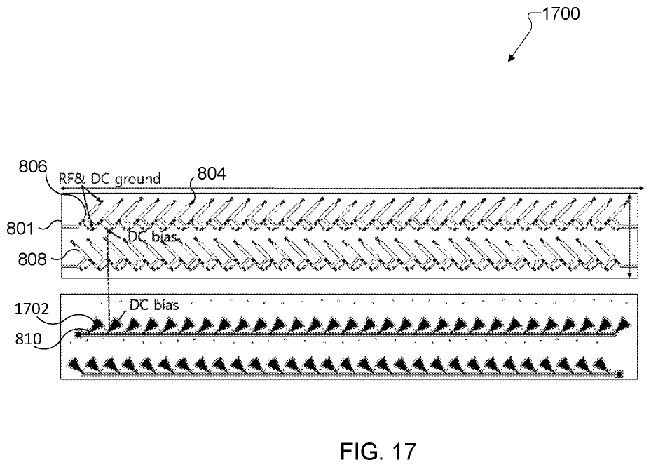

FIG. 17 illustrates an example antenna stack-up 1700 according to embodiments of the present disclosure. As illustrated in FIG. 1700, the DC bias lines 810 in the third layer 803 can have radial stubs 1702 to remove choking resistor need on first layer 801. The choking resistor provides isolation to RF signals and makes sure the DC bias lines 810 don't affect the RF performance by increasing loss. The radial stubs 1702 can have a similar effect and provides a PCB-based solution to remove the need for soldering extra components.

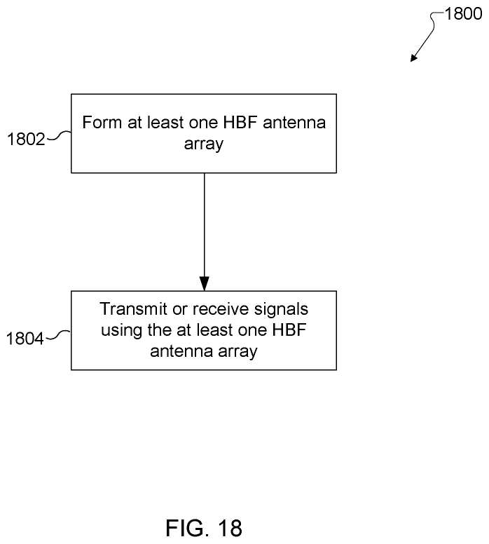

FIG. 18 illustrates a flow diagram of a method 1800 for operation a BS for communication using a HBF antenna array. In one or more embodiments the method 1800 can be performed by a BS, such as the BS 102, that includes at least one HBF antenna array according to embodiments of the present disclosure. The embodiment of the method 1800 shown in FIG. 18 is for illustration only. Other embodiments of the method 1800 for operation a BS for communication using a HBF antenna array could be used without departing from the scope of this disclosure.

The method 1800 begins with forming at least one HBF antenna array, such as the HBF antenna array 800 (1802). The HBF antenna array can be formed in the manner described in the method 700 described above. As shown above, the at least one HBF antenna array includes the first layer 801 that includes the at least one first HBF antenna line 806 and the at least one second HBF antenna line 808. The at least one first HBF antenna line 806 is oriented at a first angle and includes at least one first gap with a first varactor (varactor diode 804) formed in the gap. The at least one second HBF antenna line 808 is oriented at a second angle (that is opposite the first angle) and includes at least one second gap with a second varactor (a varactor diode 804) formed in the second gap.

The at least one HBF antenna array, as shown above, includes the second layer 802 attached to the first layer 801 and the third layer 803 attached to the second layer 802. Furthermore, as described above, the HBF antenna array 800 can be included an antenna stack-up such as the antenna stack-up 900.

Next, a transceiver, such as transceivers 210a-210n is operably coupled to the at least one HBF antenna array. The transceiver is configured to transmit or receive signals using the at least one HBF antenna array.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claim scope. The scope of patented subject matter is defined by the claims.

What is claimed is:

1. A base station (BS) comprising:
at least one holographic beam forming (HBF) antenna array including:
a first layer including:
at least one first HBF antenna line formed thereon, the at least one first HBF antenna line orientated at a first angle and including at least one first gap;
at least one second HBF antenna line formed thereon, the at least one second HBF antenna line orientated at a second angle and including at least one second gap, wherein the second angle is orientated opposite the first angle; and
at least one first varactor formed in the at least one first gap and at least one second varactor formed in the at least one second gap;
a second layer attached to the first layer and including an isolating ground plate; and
a third layer attached to the second layer and including a direct current (DC) bias line connected to both the at least one first varactor and the at least one second varactor; and
a transceiver operably coupled with the at least one HBF antenna array, the transceiver configured to transmit or receive signals using the at least one HBF antenna array.

2. The BS of claim 1, wherein the DC bias line is configured to supply a same DC voltage to the at least first one varactor and the at least one second varactor.

3. The BS of claim 1, wherein:
the at least one first HBF antenna line includes three first gaps and a first varactor positioned within each of the three first gaps, and
the at least one second HBF antenna line includes three second gaps and a second varactor positioned within each of the three second gaps.

4. The BS of claim 1, wherein a chose resistor is positioned on the at least one first HBF antenna line and the at least one second HBF antenna line.

5. The BS of claim 1, wherein the at least one HBF antenna array is attached to a superstrate via a metal spacer that includes a first airgap and a second airgap, the first airgap corresponding to the at least one first HBF antenna line and the second airgap corresponding to the at least one second HBF antenna line, and wherein the first airgap and the second airgap are separated.

6. The BS of claim 5, wherein the metal spacer has a height of at least 5 mm.

7. The BS of claim 5, wherein the superstrate includes at least one first slot corresponding to the at least one first HBF antenna line and is orientated at an angle that is opposite of the first angle, and at least one second slot corresponding to the at least one second HBF antenna line that is orientated at an angle that is opposite the second angle.

8. A holographic beam forming (HBF) antenna array comprising:
a first layer including:
at least one first HBF antenna line formed thereon, the at least one first HBF antenna line orientated at a first angle and including at least one first gap;
at least one second HBF antenna line formed thereon, the at least one second HBF antenna line orientated at a second angle and including at least one second gap, wherein the second angle is orientated opposite the first angle; and
at least one first varactor formed in the at least one first gap and at least one second varactor formed in the at least one second gap;
a second layer attached to the first layer and including an isolating ground plate; and
a third layer attached to the second layer and including a direct current (DC) bias line connected to both the at least one first varactor and the at least one second varactor; and
a transceiver operably coupled with the at least one HBF antenna array, the transceiver configured to transmit or receive signals using the at least one HBF antenna array.

9. The HBF antenna array of claim 8, wherein the DC bias line is configured to supply a same DC voltage to the at least first one varactor and the at least one second varactor.

10. The HBF antenna array of claim 8, wherein:
the at least one first HBF antenna line includes three first gaps and a first varactor positioned within each of the three first gaps, and
the at least one second HBF antenna line includes three second gaps and a second varactor positioned within each of the three second gaps.

11. The HBF antenna array of claim 8, wherein a chose resistor is positioned on the at least one first HBF antenna line and the at least one second HBF antenna line.

12. The HBF antenna array of claim 8, wherein the at least one HBF antenna array is attached to a superstrate via a metal spacer that includes a first airgap and a second airgap, the first airgap corresponding to the at least one first HBF antenna line and the second airgap corresponding to the at least one second HBF antenna line, and wherein the first airgap and the second airgap are separated.

13. The HBF antenna array of claim 12, wherein the metal spacer has a height of at least 5 mm.

14. The HBF antenna array of claim 12, wherein the superstrate includes at least one first slot corresponding to the at least one first HBF antenna line and is orientated at an angle that is opposite of the first angle, and at least one second slot corresponding to the at least one second HBF antenna line that is orientated at an angle that is opposite the second angle.

15. A method of operating a base station (BS), the method comprising:
transmitting or receiving signals using at least one holographic beam forming (HBF) antenna array including:
a first layer including:
at least one first HBF antenna line formed thereon, the at least one first HBF antenna line orientated at a first angle and including at least one first gap;
at least one second HBF antenna line formed thereon, the at least one second HBF antenna line orientated at a second angle and including at least one second gap, wherein the second angle is orientated opposite the first angle; and
at least one first varactor formed in the at least one first gap and at least one second varactor formed in the at least one second gap;
a second layer attached to the first layer and including an isolating ground plate; and
a third layer attached to the second layer and including a direct current (DC) bias line connected to both the at least one first varactor and the at least one second varactor.

16. The method of claim 15, wherein the DC bias line is configured to supply a same DC voltage to the at least first one varactor and the at least one second varactor.

17. The method of claim 15, wherein:
the at least one first HBF antenna line includes three first gaps and a first varactor positioned within each of the three first gaps, and
the at least one second HBF antenna line includes three second gaps and a second varactor positioned within each of the three second gaps.

18. The method of claim 15, wherein the at least one HBF antenna array is attached to a superstrate via a metal spacer that includes a first airgap and a second airgap, the first airgap corresponding to the at least one first HBF antenna line and the second airgap corresponding to the at least one second HBF antenna line, and wherein the first airgap and the second airgap are separated.

19. The method of claim 18, wherein the metal spacer has a height of at least 5 mm.

20. The method of claim 18, wherein the superstrate includes at least one first slot corresponding to the at least one first HBF antenna line and is orientated at an angle that is opposite of the first angle, and at least one second slot corresponding to the at least one second HBF antenna line that is orientated at an angle that is opposite the second angle.
